(19) United States
(12) Patent Application Publication
(10) Pub. No.: US 2016/0211609 A1
(43) Pub. Date: Jul. 21, 2016

(54) MAGNETICALLY HELD CHARGER PLUG FOR MOBILE DEVICES

(71) Applicant: Yeoshua Sorias, Brooklyn, NY (US)

(72) Inventor: Yeoshua Sorias, Brooklyn, NY (US)

(21) Appl. No.: 14/997,770

(22) Filed: Jan. 18, 2016

Related U.S. Application Data
(60) Provisional application No. 62/105,097, filed on Jan. 19, 2015.

(51) Int. Cl. H01R 13/62

(52) U.S. Cl. CPC H01R 13/6205

(57) ABSTRACT

A charger adaptor for a mobile device that has a connection socket, the charger adaptor includes: an insertion plug formed with a plurality of contact electrodes, the insertion plug having a shape complementary to an interior shape of the connection socket; a plug body extending away from the insertion plug and extending outside the connection socket, the plug body having exteriorly facing electrical contacts that are in respective electrical continuity with the contact electrodes; and the plug body comprising at least one of a magnetic material to produce a magnetic attractive force that is configured to hold to the plug body an accessory charging plug head to make electrical contact with the contact electrodes of the plug body, and a ferromagnetic material that is magnetically drawn to magnetic material in the plug head.

### CROSS REFERENCE OF THE RELATED APPLICATION(S)

This present application claims benefit of and priority to U.S. Provisional Application No. 62/105,907 filed on Jan. 21, 2015 by Yeoshua SORIAS and entitled “MAGNETICALLY HELD CHARGER PLUG FOR MOBILE DEVICES,” and U.S. application Ser. No. 29/536,591 filed on Aug. 18, 2015 by Yeoshua SORIAS and entitled “MAGNETICALLY HELD CHARGER PLUG FOR MOBILE DEVICES,” the entire contents of which are hereby incorporated by reference.

### BACKGROUND OF THE INVENTION

The present invention is directed to a charger for mobile devices, such as telephones, tablets and the like and, more particularly, to such a charger which is held to the mobile device magnetically.

With initial reference to prior art FIG. 1, there is shown therein a mobile device 10, for example, a cell phone, with a body 12, a display 14, a keyboard 16, and a female charging socket 20 having internal surface pins or electrical contacts 22.

In well known manner, a charger 30 is connected by a cable 32 to a plug 34 having A/C prongs 36, to provide A/C voltage that is rectified within the charger 30 to a low D/C voltage of, for example, 5 volts. The male plug body 37 has electrical pins 38 sized to fit into the normally tiny socket 20 to enable charge to pass into the mobile device 10 and charge its internal battery (not shown).

The coupling between the plug 37 and the internal socket is prone to breakage, because it relies on tiny and weak physical structures fitting within a charger and lacking sufficient rigidity to prevent bending or breaking when they are accidentally knocked against or bent or otherwise disturbed.

### SUMMARY OF THE INVENTION

It is an object of the present invention to avoid or at least ameliorate the aforementioned drawbacks of the prior art.

It is another object of the invention to provide a charger plug for conventional mobile devices which relies on magnetism to hold the charger head or plug to the phone.

The foregoing and other objects of the invention are realized by providing an adapter that is permanently plugged into the charging socket of the mobile device and remains there. A complementary plug head is brought against the adapter and held there magnetically with electrical connections being made by electrical contacts on the plug and on the socket side being held in contact with each other magnetically.

In accordance of preferred embodiments, the charger adaptor for a mobile device that has a connection socket, comprises: an insertion plug formed with a plurality of contact electrodes, the insertion plug having a shape complementary to an interior shape of the connection socket; a plug body extending away from the insertion plug and extending outside the connection socket, the plug body having exteriorly facing electrical contacts that are in respective electrical continuity with the contact electrodes; and the plug body comprising at least one of a magnetic material to produce a magnetic attractive force that is configured to hold to the plug body an accessory charging plug head to make electrical contact with the contact electrodes of the plug body, and a ferromagnetic material that is magnetically drawn to magnetic material in the plug head. The charger adaptor can be so wherein the magnetic material comprises a strip of magnetic material. Or, the magnetic material comprises a plurality of discreet magnets embedded in the plug body.

Preferably, the charger adaptor further including a charging plug that comprises said accessory charging plug head, said charging plug having a forward face supporting a plurality of electrical pins configured to make electrical contact with the contact electrodes of the plug body and being held magnetically to the plug body. The electrical pins may be resiliently biased against the contact electrodes. The magnetic material may be located at the plug body. The plug body may comprise the ferromagnetic material.

The plug body may comprise a skirt which defines a recess for receiving the accessory charging plug head. The plug body comprises an N-S magnet and the charging plug comprises its own respective N-S magnet, thereby to allow attraction of the plug body with the charging plug only in one orientation. The charge plug may comprise a cable with an AC plug. The cable and the charging plug may be separable from one another and the charging plug may be provided with a female socket. The plug body preferably has a thickness dimension in the range from 1.5 to 4 mm.

These and other objects of the invention will become apparent from the following description of the invention which refers to the accompanying drawings.

### BRIEF DESCRIPTION OF THE DRAWINGS

FIG. 1 shows a prior art arrangement of a charger system for a mobile device.

FIG. 2 shows an adapter and complementary plug that are intended to be magnetically held to each other.

FIGS. 2A through 2C show another embodiment of the adaptor and complementary plug of FIG. 2.

FIG. 2D shows a minor variation to the adaptor of FIG. 2A.

FIG. 3 perspectively shows components of the present invention.

### DETAILED DESCRIPTION OF EMBODIMENTS OF THE INVENTION

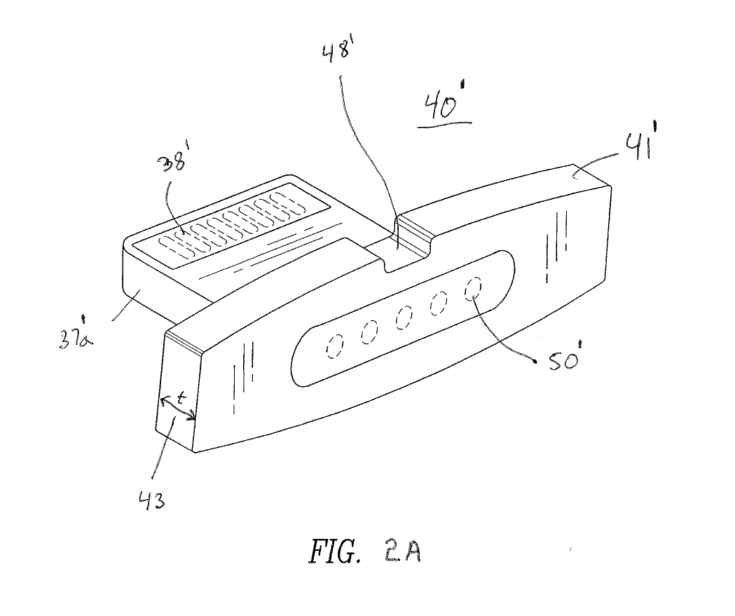

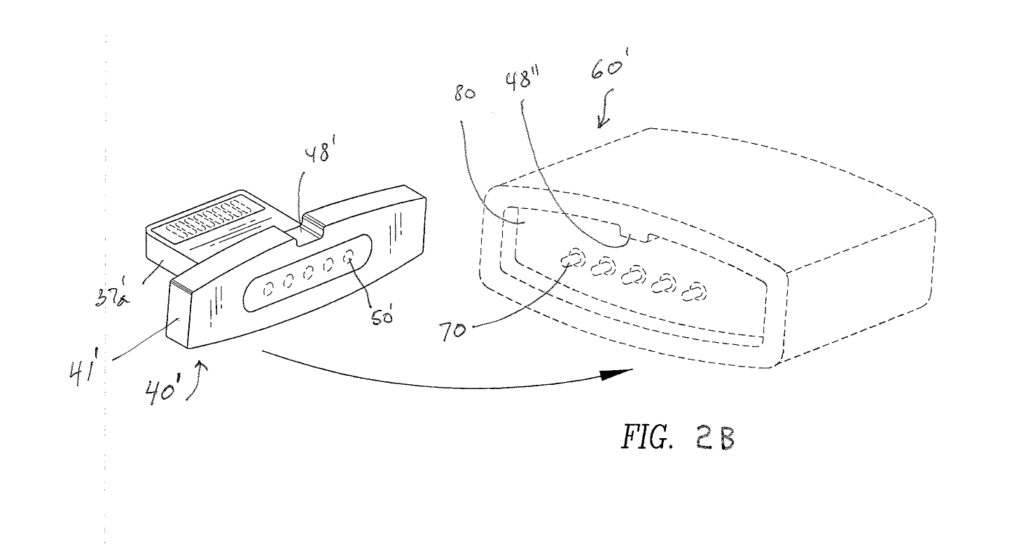

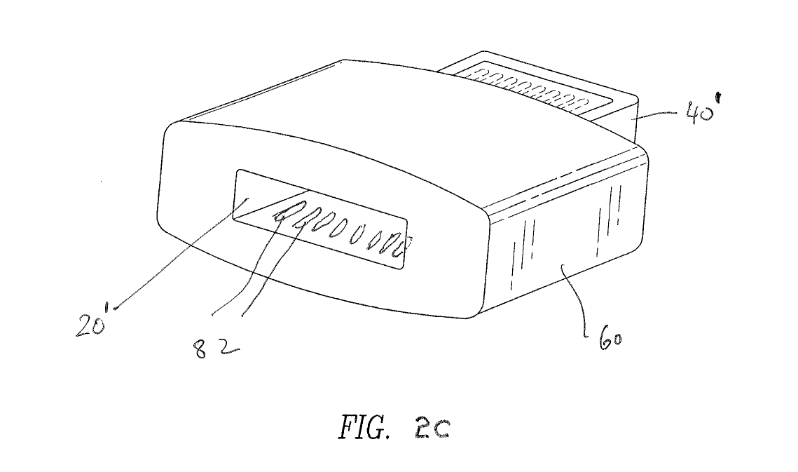

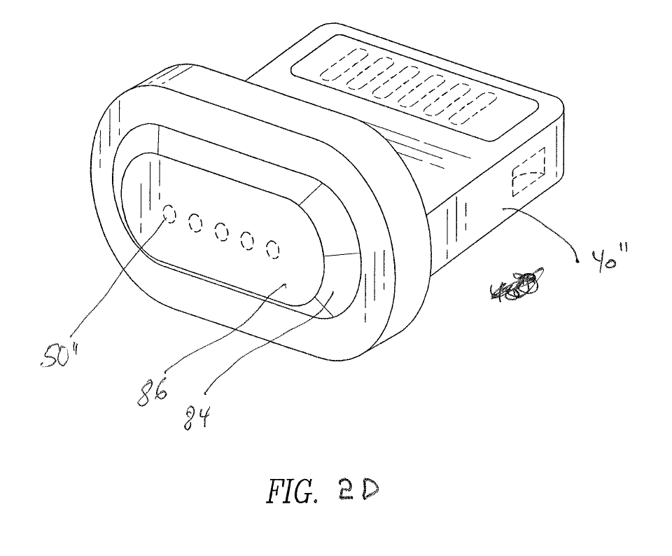

With reference to FIG. 2, a charger adapter 40, shown on the left side of FIG. 2, comprises in accordance with the present invention, a body 41 that supports on one face thereof an insertable plug 37a with electrical contacts 38. The plug body 37a has a shape and dimensions precisely configured to fit within conventional mobile device charging sockets. Of course, these dimensions differ in different mobile devices, such as telephones, tablets and the like that are on the market. The body 41 is surrounded or has embedded in it magnetic material 42. The magnetic material can be embedded within the body 41, or can be provided as a strip of a certain thickness surrounding the body, or as numerous tiny embedded magnets, and in many other manners that would be obvious to one of ordinary skill in the art.

The opposed side of the body 41 defines edge fingers or a skirt 46 defining between them a cavity 44 in which are provided bulging or surface-flush electrical contacts 50.

In accordance with a further aspect of the invention, the charging plug 60 has a body 61 which is similarly provided with one or more or a strip of magnets 62, very similarly as described in reference to the adapter 40. Alternatively, the charging plug may just contain a ferromagnetic material that is attracted to the magnets or the magnetic material in the body 41. Alternatively, the charging plug 60 contains the magnetic material and the plug body 41 is made of or contains ferromagnetic material, for example steel. In one contemplated embodiment, the magnet in the body 41 has N-S poles and the charging plug also has an N-S magnet whereby the body 41 and plug 60 can hold to one another only in one orientation, that is with their magnet poles properly aligned, thereby maintaining the electrical connections properly aligned.

Referring again to FIG. 2, the charging plug 60 is connected via an electrical cable 32 to an A/C plug 32 having prongs 36. The A/C voltage may be rectified either in plug 34 or in the body 60. Where the A/C to D/C converter is located is not important and of no significance. However, the rectified D/C voltage is provided to electrical contacts 70 that are located so as to face the contacts 50 of the adapter 40. The contacts 70 may also be bulging, but could be concave or recessed into the body 61. When the charging plug 60 is brought close to the adapter 40, the magnetic forces will hold tightly together the two connectors so that there is a solid and reliable electrical contact between the electrodes 50, 70. Nonetheless, should any bending force or a jerking force be applied to the either the telephone body or to the charging plug, the contact between the electrodes will break without actually causing any harm to either side, namely neither to the adapter 40 nor to the charging plug 60.

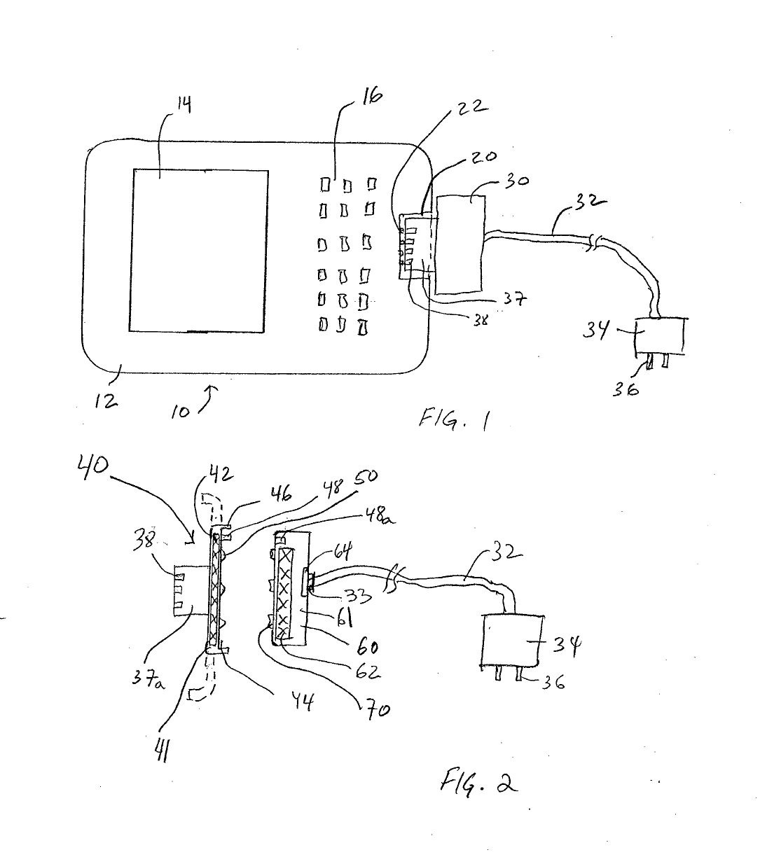

To assure that the plug 60 is brought toward the adapter in the correct orientation, an orienting finger 48 is configured to penetrate an opening 48a to enable coupling only in the correct configuration. When the plug and the adapter are connected to each other, the electrical wires providing the charging voltage enable charge to flow from the contacts 70 to the contacts 50 and then to the contacts 38 and ultimately to the electrical contacts 22, which are permanently provided in the mobile device (see FIG. 1). The outerskirt or fingers 46 also assures easy insertion and alignment of the plug 60 into the opening 44 of the adapter 40. Optionally, the adapter 40 has extensions that wrap around the corners of the mobile device in FIG. 4 and thereby hold onto the body of the mobile device 10.

The instant inventor also contemplates the option of applying a somewhat sticky glue to the plug 37a, so that it will not easily be removed from the phone and will positively hold onto the mobile device. The thickness of the body 41 of the adapter 40 may be on the order of literally 2 millimeters or even thinner, so that it does not materially change the size of the mobile device or interfere with the comfort of holding it in one's hand.

It should also be apparent to one of skill in the art that the inventor contemplates that the charging side of FIG. 2, including the plug head 60, would be standard and not vary from phone device to device. However, one would purchase different adapters 40 for different phones, in order to accommodate the particular socket of the given mobile device. The adapter 40 may be provided at the bottom of the phone or on the side or at the top thereof, depending on where on the mobile device body the charging port/socket is located.

It is also contemplated that the plug body 60 might be held within the socket entirely due to friction between its outer surfaces and/or by several jutting fingers 48 being pushed into tight openings in the plug 60. Even if unwanted force is applied to the plug, the adapter might break, but the mobile device would remain unharmed.

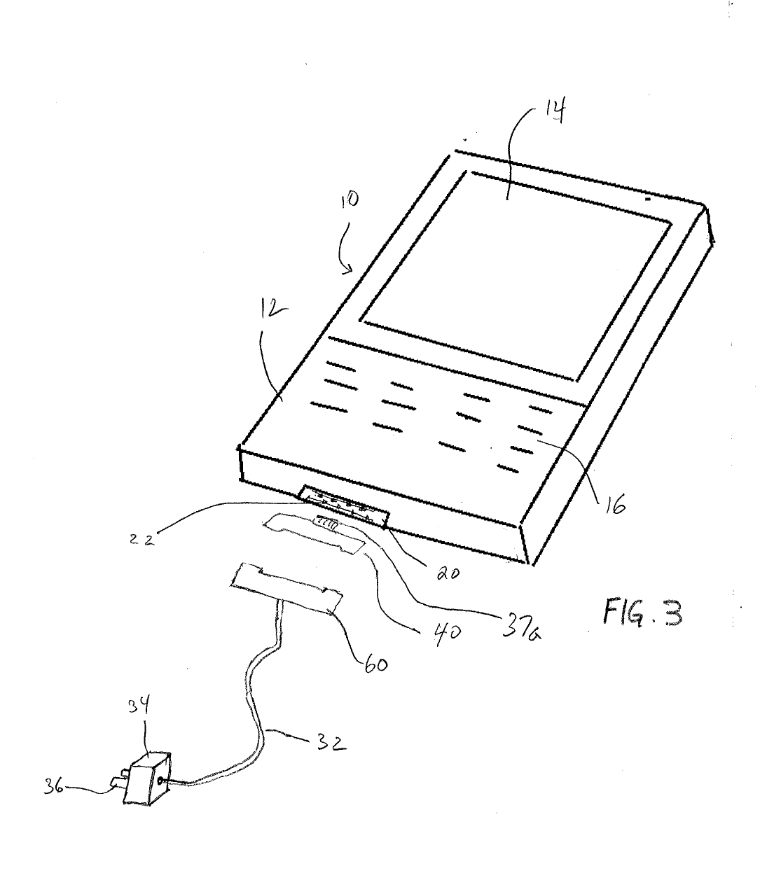

FIG. 3 shows the invention in exploded view, including the adapter 40 with its plug head 37a and the charging plug 60, wherein the plug and the adapter 40 are held to each other magnetically, rather than frictionally, as does the adapter 40 to the mobile device 10.

As shown in FIG. 2, the plug 60 can be a standalone piece with a standard charging socket 64, e.g., a USB socket, designed to accept a standard charger plug 33 that is at the distal end of the cable 32. Thus, users could purchase the adapter 40 and plug 60 and so be able to charge their mobile device with existing chargers.

Referring to FIG. 2A, the modified charger adaptor 40′ has an insertable plug 37a′ with electrical contacts 38′, a body 41′ with an orientation indent 48′ and surface-flush, electrical contacts 50′. The thickness “t” indicated by 43 measures about 2 millimeters. Embedded within the body 41′ are the aforementioned magnetic components, or the body 41′ can comprise ferromagnetic material instead.

Thus, referring to FIG. 2B, it can be seen that the adaptor 40′, when mounted into a cell-phone socket, will have its plug 37a′ invisible except for the body 41′ that protrudes out at a thickness of from 1.5 to 3, preferably about 2 millimeters. A charging plug adaptor 60′ has at the front thereof a recess 80 with an orientation projection 48′, and an overall shape that fits tightly and directly around the adaptor body 41′. The electrical pin contacts 70 make electrical contact with the contacts 50′. The depth of the recess 80 is also on the order of about 2 millimeters. The pins 70 can be spring-mounted so that they are biased against and apply some force on the electrodes 50, whereby even if the charging plug 60′ is tilted left or right or up or down or vibrates in use, the electrical contact is maintained.

As shown in FIG. 2C, the charger adaptor 40′ is installed in the charging plug 60, the rear of which is formed with a socket 20′ identical to one that one would see in the mobile device 10, and has internal contacts 82, whereby an ordinary telephone charger can be inserted thereinto.

Referring to FIG. 2D, there is shown herein a charger adaptor 40″ which in all material aspects is like the one shown in FIG. 2A, except that it has a projecting connector 86 with sloping, circumferentially extending sides, so that a complementary charging plug would fit directly therearound.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. A charger adaptor for a mobile device that has a connection socket, the charger adaptor comprising:
an insertion plug formed with a plurality of contact electrodes, the insertion plug having a shape complementary to an interior shape of the connection socket;
a plug body extending away from the insertion plug and extending outside the connection socket, the plug body having exteriorly facing electrical contacts that are in respective electrical continuity with the contact electrodes; and
the plug body comprising at least one of a magnetic material to produce a magnetic attractive force that is configured to hold to the plug body an accessory charging plug head to make electrical contact with the contact electrodes of the plug body, and a ferromagnetic material that is magnetically drawn to magnetic material in the plug head.

2. The charger adaptor of claim 1, wherein the magnetic material comprises a strip of magnetic material.

3. The charger adaptor of claim 1, wherein the magnetic material comprises a plurality of discreet magnets embedded in the plug body.

4. The charger adaptor of claim 1, further including a charging plug that comprises said accessory charging plug head, said charging plug having a forward face supporting a plurality of electrical pins configured to make electrical contact with the contact electrodes of the plug body and being held magnetically to the plug body.

5. The charger adaptor of claim 4, wherein the electrical pins are resiliently biased against the contact electrodes.

6. The charger adaptor of claim 1, wherein the magnetic material is located at the plug body.

7. The charger adaptor of claim 1, wherein the plug body comprises the ferromagnetic material.

8. The charger adaptor of claim 1, wherein the plug body comprises a skirt which defines a recess for receiving the accessory charging plug head.

9. The charger adaptor of claim 4, wherein said plug body comprises an N-S magnet and the charging plug comprises its own respective N-S magnet, thereby to allow attraction of the plug body with the charging plug only in one orientation.

10. The charger adaptor of claim 1, wherein the charge plug also comprises a cable with an AC plug.

11. The charger adaptor of claim 10, wherein the cable and the charging plug are separable from one another and the charging plug is provided with a female socket.

12. The charger adaptor of claim 1, wherein the plug body has a thickness dimension in the range from 1.5 to 4 mm.

13. The charger adaptor of claim 12, wherein the thickness dimension of the plug body is less then about 2.0 mm.

14. The charger adaptor of claim 1, wherein the plug body comprises an orienting element.

15. The charger adaptor of claim 1, wherein the plug head comprises a respective plug orienting element.
